(19) United States
(12) Patent Application Publication
(10) Pub. No.: US 2011/0115665 A1
(43) Pub. Date: May 19, 2011

(54) BEAM STEERING SYSTEM OF PHASED ARRAY ANTENNA USING FREQUENCY

(75) Inventor: Seong Hyun Ryu, Yongin (KR)

(73) Assignee: LIG Nex1 Co., Ltd., Seoul (KR)

(21) Appl. No.: 12/944,640

(22) Filed: Nov. 11, 2010

(30) Foreign Application Priority Data
Nov. 13, 2009 (KR) 10-2009-0109819

(51) Int. Cl. G01S 13/00

(52) U.S. Cl. 342/21

(57) ABSTRACT

Provided is a beam steering system of a phased array antenna using a frequency. The beam steering system according to the present invention includes: a plurality of transmitting/receiving front-ends including phase shifters for adjusting phases of inputted signals; a plurality of array antennas emitting signals outputted from the transmitting/receiving front-ends to free space; and a wideband transmitter generating the signals inputted into the transmitting/receiving front-ends, wherein the wideband transmitter generates the signals by varying frequencies of the signals in accordance with a control signal inputted from the outside. According to the exemplary embodiment of the present invention, by generating the signals by varying the frequencies of signals inputted into the phase shifters of transmitting/receiving front-ends, it is possible to generate a beam steering angle through a simple control without changing the phase of the phase shifter.

### BACKGROUND OF THE INVENTION

1. Field of the Invention

The present invention relates to a beam steering system used in a radar, and more particularly, to a beam steering system of a phased array antenna using a frequency.

2. Description of the Related Art

In general, a radar system, which transmits electromagnetic waves to a predetermined object through an antenna having high directionality and receives reflected waves from the object to measure a distance and a direction up to the object, is being used for various fields including safety ensuring through the searching and guiding of a ship or an aircraft.

In particular, in the case in which an antenna having high directionality, low sidelobe level, rapid beam scanning, and low power characteristics is required in an antenna field, a phased array antenna is commonly, used. The phased array antenna scans a beam by electronically controlling the phase of power supplied to array elements instead of scanning the beam of the antenna through mechanical rotation. Therefore, since the phased array antenna can instantly vary the shape and direction of the beam, the phased array antenna has been receiving much attention.

FIG. 1 is a schematic diagram of a known phased array antenna. As shown in FIG. 1, the phased array antenna includes M antennas 1 and phase shifters 2 adjusting the phase of signals received by the antennas 1. An operation of the phased array antenna will be described below.

The phase shifter 2 appropriately adjusts the phase, of the signal received by each antenna 1 in accordance with the control of a controller (not shown) and outputs the signal to the antenna 1. In this case, since electromagnetic waves transmitted by the antennas 1 have different phases depending on the antenna, the orientation direction of the beam is determined depending on the phase set by the phase shifter 2 in a space. Specifically, when the phase shifters 2 appropriately adjust the phases of the signals received by the array antennas 1 in accordance with the control of the controller (not shown), a temporal difference occurs in the phase of electromagnetic signals transmitted by the array antennas 1 and the antenna beam becomes oriented at a predetermined angle θ by the Huygen's principle.

As described above, in the case of the conventional phased array antenna, the phase for forming a desired beam steering angle needs to be controlled for each antenna in order to steer the beam.

### SUMMARY OF THE INVENTION

The conventional phased array antenna is complicated to control and cannot generate multiple beam steering angles at the same time since phase needs to be controlled for each antenna in order to generate single beam steering angle.

Therefore, the present invention has been made in an effort to provide a beam steering system using a phased array antenna capable of generating a beam steering angle through a simple control and generating multiple beam steering angles at the same time.

An exemplary embodiment of the present invention provides a beam steering system of a phased array antenna using a frequency, the system including: a plurality of transmitting/receiving front-ends including phase shifters for adjusting phases of inputted signals; a plurality of array antennas emitting signals outputted from the transmitting/receiving front-ends to free space; and a wideband transmitter generating the signals inputted into the transmitting/receiving front-ends, wherein the signals are generated by varying frequencies of the signals in accordance with a control signal inputted from the outside.

Herein, the beam steering system may further include a wideband receiver receiving the signals introduced into the array antennas, wherein the signals are received in a predetermined frequency band in accordance with the control signal.

Further, the frequency band of the signal generated from the wideband transmitter may be synchronized with the frequency band of the wideband receiver.

In addition, the beam steering system may further include a controller generating the control signal.

Another exemplary embodiment of the present invention provides a beam steering system of a phased array antenna using a frequency, the system including: a plurality of transmitting/receiving front-ends including phase shifters for adjusting phases of inputted signals; a plurality of array antennas emitting signals outputted from the transmitting/receiving front-ends to free space; and a wideband transmitter generating the signals inputted into the transmitting/receiving front-ends, wherein the signals having a plurality of frequency bands are generated.

Herein, the beam steering system may further include a wideband receiver receiving the signals introduced into the array antennas, wherein the signals are received in the plurality of frequency bands.

Further, the wideband transmitter may generate the signals by varying the plurality of frequency bands in accordance with a control signal inputted from the outside.

In addition, the wideband receiver may receive the signal in a predetermined frequency band in accordance with the control signal inputted from the outside.

Moreover, the frequency band of the signal generated from the wideband transmitter may be synchronized with the frequency band of the wideband receiver.

According to the exemplary embodiments of the present invention, by varying and generating frequencies of signals inputted into phase shifters, it is possible to generate multiple beam steering angels through a simple control without changing phase information of the phase shifter for each steering angle in accordance with multiple beam steering angles to be generated.

Further, according to the exemplary embodiments of the present invention, it is possible to generate multiple beam steering angles at the same time by generating signals of multiple frequency bands with the signals inputted into the phase shifters at the same time.

### BRIEF DESCRIPTION OF THE DRAWINGS

FIG. 1 is a schematic diagram of a known phased array antenna;

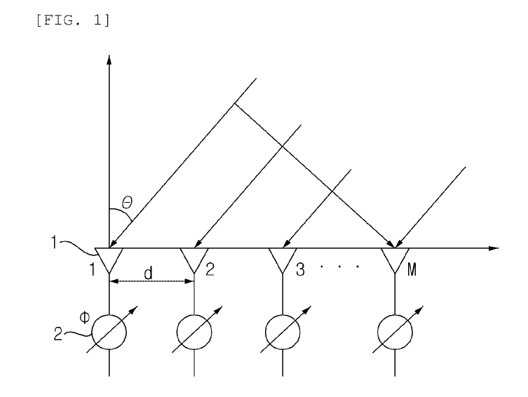

FIG. 2 is a conceptual diagram illustrating a beam steering angle control principle according to an exemplary embodiment of the present invention;

FIG. 3 is a configuration diagram of a beam steering system using a phased array antenna according to an exemplary embodiment of the present invention;

FIG. 4A illustrates an example of a frequency band of a signal generated by a wideband transmitter 50 according to an exemplary embodiment of the present invention and FIG. 4B illustrates the resulting emitting pattern of an antenna; and

FIG. 5A illustrates an example of a frequency band of a signal generated by a wideband transmitter 50 according to another exemplary embodiment of the present invention and FIG. 5B illustrates the resulting emitting pattern of an antenna.

### DETAILED DESCRIPTION OF THE EMBODIMENTS

Hereinafter, exemplary embodiments of the present invention will be described in detail with reference to the accompanying drawings. In the following description and drawings, like components refer to like reference numerals and therefore, the duplicated description thereof will be omitted. In addition, the detailed description of known functions and configurations will be omitted so as not to obscure the subject of the present invention with unnecessary detail.

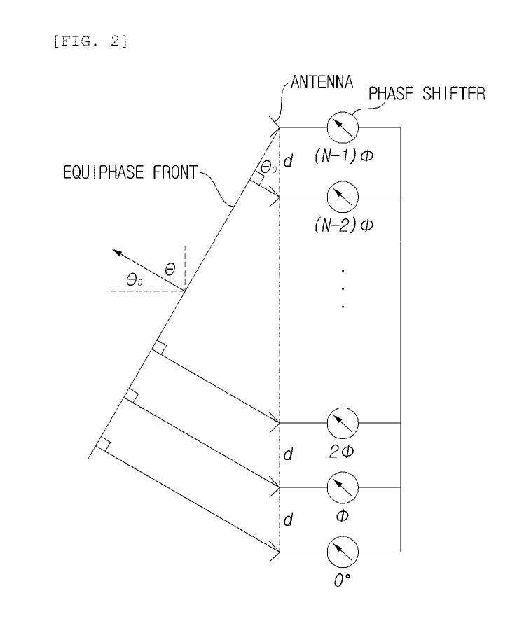

According to an exemplary embodiment of the present invention, a beam steering angle is controlled using a frequency of a signal inputted into a phase shifter. FIG. 2 is a conceptual diagram illustrating a beam steering angle control principle according to an exemplary embodiment of the present invention.

Referring to FIG. 2, N antennas and N phase shifters adjusting phases of signals inputted into antennas and outputting the signals are shown. In the case of N phase shifters, phase of N antennas are set to generate a beam steering angle θ₀ like the known antenna. The phase difference Φ among the antennas for generating the beam steering angle can be obtained as follows.

An array factor (AF) can be obtained by the following equation.

$$AF = {\sum }_{n = 0}^{N - 1} {e}^{- j n Ψ} \qquad [ Equation 1 ]$$

The phase difference Φ among the antennas is acquired by the following equation.

ψ=kⱼd cos θ−φ, φ=kⱼd sin θₒ. [Equation 2]

Herein, θ=90°−θ₀, d represents a distance between the antennas and K_{f} represents a wave number at a frequency f.

In this case, the following equation is obtained from Φ=kⱼd sin θₒ.

$${θ}_{0} = {sin}^{- 1} ( \frac{φ}{{k}_{f} d} ) \qquad [ Equation 3 ]$$

Herein,

$${k}_{f} = \frac{{2}_{π} f}{c} ,$$

as a result, k_{f} varies depending on frequency f. Accordingly, the beam steering angle θ₀ also varies depending on frequency f. Therefore, it is possible to adjust the beam steering angle by varying k_{f} through adjusting frequency f while fixing the phase difference between the antennas to Φ. For example, it is possible to generate different beam steering angles θ₀₁ and θ₀₂ by using two frequencies f₁ and f₂ with respect to one phase difference Φ.

$${θ}_{01} = {sin}^{- 1} ( \frac{φ}{{k}_{f 1} d} ) \\ {θ}_{02} = {sin}^{- 1} ( \frac{φ}{{k}_{f 2} d} ) \qquad [ Equation 4 ]$$

Therefore, the beam steering system according to the exemplary embodiment of the present invention generates a desired beam steering angle by adjusting the frequency of the signal inputted into the phase shifter.

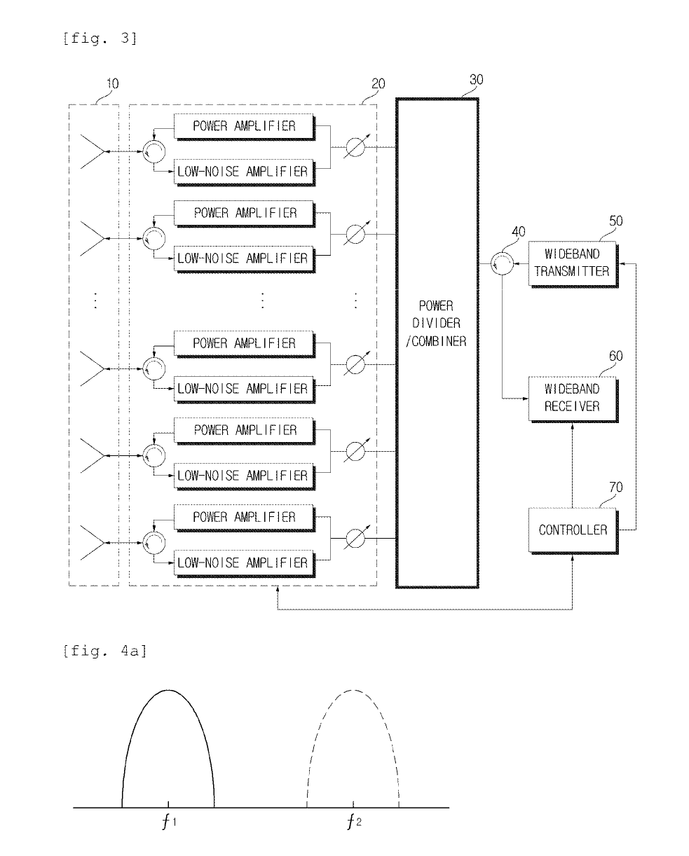

FIG. 3 is a configuration diagram of a beam steering system of a phase array antenna using a frequency according to an exemplary embodiment of the present invention. The beam steering system according to the exemplary embodiment uses a 2-dimensional phased array antenna. The present invention can be easily appreciated to those skilled in the art that the present invention can be applied even to a 1-dimensional phased array antenna and a 3-dimensional phased array antenna through the principle of the present invention and a description to be made below.

The beam steering system according to the exemplary embodiment includes array antennas 10 arrayed in a vertical direction, transmitting/receiving front-ends 20 connected to the array antennas 10, and a power divider/combiner 30, a circulator 40, a wideband transmitter 50, a wideband receiver 60, and a controller 70 as shown in the figure.

The array antennas 10 emit signals outputted from the transmitting/receiving front-ends 20 to free space or transfer signals introduced from the free space to the transmitting/receiving front-ends 20.

Each of the transmitting/receiving front-ends 20 include a circulator, a power amplifier, a low-noise amplifier, and a phase shifter as shown in the figure and adjusts the phase of a signal inputted from the power divider/combiner 30 through the phase shifter and power-amplifies the signal through the power amplifier and thereafter, transfers the corresponding signal to the array antennas 10 during transmitting mode and low-noise-amplifies the signals inputted from the array antennas 10 through the low-noise amplifier. Then, each of the transmitting/receiving front-ends 20 adjusts the phase of the corresponding signals through the phase shifter and outputs the corresponding signals to the power divider/combiner 30 during receiving mode. The phase of the phase shifters in the transmitting/receiving front-ends 20 is set depending on a control from the controller 70 to be described later so that the array antennas 10 generate a predetermined beam steering angle.

The power divider/combiner 30 combines powers of the signals outputted from the transmitting/receiving front-ends 20 and transfers the combined powers to the circulator 40 to be described later or divides the signals inputted into the circulator 40 by using the same power and transfers the divided signals to the transmitting/receiving front-ends 20.

The circulator 40 transfers a transmission signal of the wideband transmitter 50 to be described later to the power divider/combiner 30 and transfers a reception signal from the power divider/combiner 30 to the wideband receiver 60 to be described below. The circulator 40 serves to allow both transmitting and receiving processes to be performed through the array antennas 10, the transmitting/receiving front-ends 20, and the power divider/combiner 30. A switch may substitute for the circulator 40.

Referring to the transmitting process, when transmitting power generated by the wideband transmitter 50 is transferred to the power divider/combiner 30, the power divider/combiner 30 divides power by using multiple signals and transfers the divided power to the transmitting/receiving front-ends 20 and the transmitting/receiving front-ends 20 perform power-amplification and phase-adjustment of the signals and transfer them to the array antennas 10.

Referring to the receiving process, low-noise amplification and phase adjustment of the signals introduced into the array antennas 10 are performed in the transmitting/receiving front-ends 20 and the signals are transferred to the wideband receiver 60 through the power divider/combiner 30 and the circulator 40.

The controller 70 generates a control signal in accordance with user command or a predetermined program to set the phase of the phase shifter of each of the transmitting/receiving front-ends 20, sets the frequency of the signal generated in the wideband transmitter 50, or set the frequency band of the signal received by the wideband receiver 60.

The wideband transmitter 50 generates the transmission signals to be inputted into the transmitting/receiving front-ends 20. In the exemplary embodiment of the present invention, the wideband transmitter 50 varies the frequency of the transmission signal and outputs the corresponding signal in accordance with the control signal inputted from the controller 70.

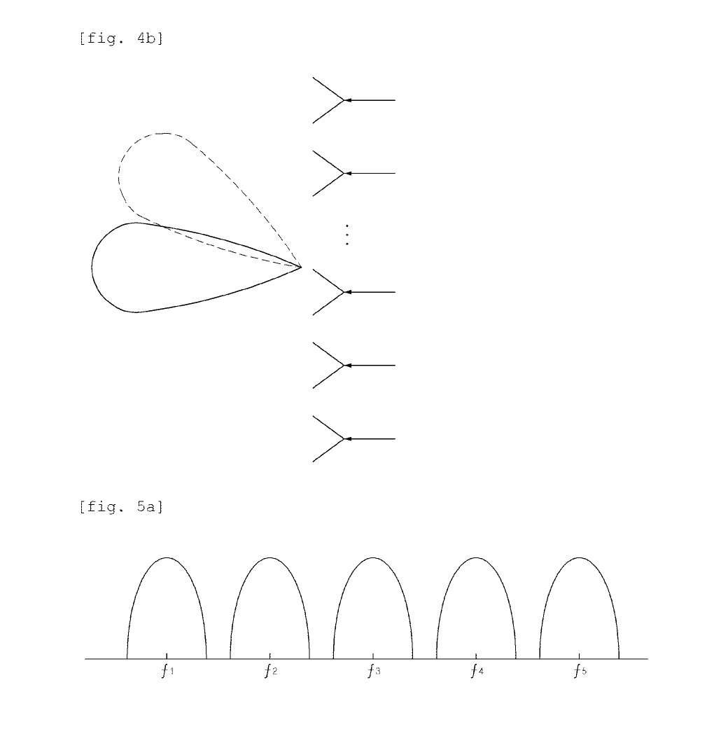

In the case in which the phase of the phase shifter of each of the transmitting/receiving front-ends 20 is set to generate a predetermined beam steering angle, the wideband transmitter 50 outputs the corresponding signal by varying the frequency of the transmission signal, such that the beam steering angle varies. For example, in the case in which an emitting pattern of the antenna is marked by a solid line of FIG. 4B when the signal outputted from the wideband transmitter 50 is a signal of a predetermined band using f₁ as a center frequency as shown in FIG. 4A, the emitting pattern of the antenna may be changed as marked with a dotted line of FIG. 4B when the signal outputted from the wideband transmitter 50 is a signal of a predetermined band using f₂ as the center frequency as shown in FIG. 4A. The correspondence relationship between the frequency and the beam steering angle is previously calculated by using Equation 3 described above or experimentally to be stored in the controller 70 or may be provided to an operator of the beam steering system.

The wideband receiver 60 receives signals which are received by the array antennas 10 and passed through the transmitting/receiving front-ends 20. In the exemplary embodiment of the present invention, the wideband receiver 60 receives the signals in a predetermined band in accordance with the control signal inputted from the controller 70.

In the case in which the phase of the phase shifter of each of the transmitting/receiving front-ends 20 is set to generate a predetermined beam steering angle, the beam steering angle varies depending on the band of the received frequency of the wideband receiver 60. As described the example related to the wideband transmitter 50, the emitting pattern of the antenna during receiving mode may be changed as shown in FIG. 4B by changing the center frequency f₁ to the center frequency f₂ of the received frequency band as shown in FIG. 4A.

In addition, the frequency bands of the wideband transmitter 50 and the wideband receiver 60 may be synchronized with each other. That is, the controller 70 inputs the same control signal to the wideband transmitter 50 and the wideband receiver 60 and the wideband receiver 60 may receive the signal in the same frequency band as the frequency band of the signal outputted from the wideband transmitter 50.

When the wideband transmitter 50 generates the transmission signals to be inputted into the transmitting/receiving front-ends 20, the wideband transmitter 50 outputs signals of multiple frequency bands in another exemplary embodiment of the present invention.

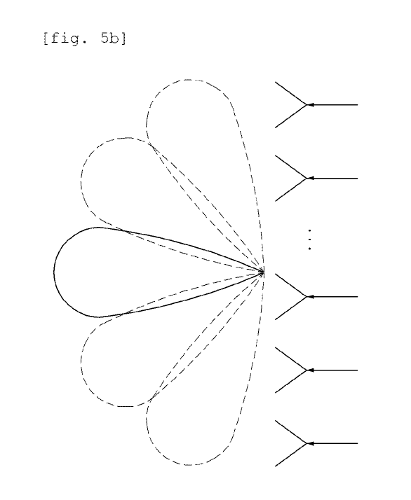

In the case in which the phase of the phase shifter of each of the transmitting/receiving front-ends 20 is set to generate a predetermined beam steering angle, the wideband transmitter 50 may generate multiple beam steering angles by outputting the signals of the multiple frequency bands. For example, when the signals outputted from the wideband transmitter 50 are signals of 5 frequency bands using f₁, f₂, f₃, f₄, and f₅ as the center frequencies as shown in FIG. 5A, multiple emitting patterns may be formed as the emitting pattern of the antenna as shown in FIG. 5B. The frequency bands of the signals outputted from the wideband transmitter 50 may vary depending on the control from the controller 70. In this case, the emitting patterns may also be changed.

When the wideband receiver 60 receives the signals which are received by the array antennas 10 and passed through the transmitting/receiving front-ends 20, the wideband receiver 60 receives the signals in the multiple frequency bands in another exemplary embodiment of the present invention.

Like the example related to the wideband transmitter 50, by setting the receiving frequency band as the frequency band using as the center f₁, f₂, f₃, f₄, and f₅ frequencies as shown in FIG. 5A, multiple emitting patterns may be formed as the emitting pattern during receiving mode as shown in FIG. 5B. The receiving frequency bands of the wideband receiver 60 may vary depending on the control from the controller 70. In this case, the emitting patterns during receiving mode may also be changed.

Even in the exemplary embodiment, the frequency bands of the wideband transmitter 50 and the wideband receiver 60 may be synchronized with each other. That is, the wideband receiver 60 may receive the signal in the same frequency band as the frequency band of the signal outputted from the wideband transmitter 50.

Hitherto, the present invention has been described based on the exemplary embodiments. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The protection scope of the present invention must be analyzed by the appended claims and it should be analyzed that all spirits within a scope equivalent thereto are included in the appended claims of the present invention.

What is claimed is:

1. A beam steering system of a phased array antenna using a frequency, comprising:
a plurality of transmitting/receiving front-ends including phase shifters for adjusting phases of inputted signals;
a plurality of array antennas emitting signals outputted from the transmitting/receiving front-ends to free space; and
a wideband transmitter generating the signals inputted into the transmitting/receiving front-ends, wherein the signals are generated by varying frequencies of the signals in accordance with a control signal inputted from the outside.

2. The beam steering system of claim 1, further comprising a wideband receiver receiving the signals introduced into the array antennas, wherein the signals are received in a predetermined frequency band in accordance with the control signal.

3. The beam steering system of claim 2, wherein the frequency band of the signal generated from the wideband transmitter is synchronized with the frequency band of the wideband receiver.

4. The beam steering system of claim 1, further comprising a controller generating the control signal.

5. A beam steering system of a phased array antenna using a frequency, comprising:
a plurality of transmitting/receiving front-ends including phase shifters for adjusting phases of inputted signals;
a plurality of array antennas emitting signals outputted from the transmitting/receiving front-ends to free space; and
a wideband transmitter generating the signals inputted into the transmitting/receiving front-ends, wherein the signals having a plurality of frequency bands are generated.

6. The beam steering system of claim 5, further comprising a wideband receiver receiving the signals introduced into the array antennas, wherein the signals are received in the plurality of frequency bands.

7. The beam steering system of claim 5, wherein the wideband transmitter generates the signals by varying the plurality of frequency bands in accordance with a control signal inputted from the outside.

8. The beam steering system of claim 6, wherein the wideband receiver receives the signal in a predetermined frequency band in accordance with the control signal inputted from the outside.

9. The beam steering system of claim 6, wherein the frequency band of the signal generated from the wideband transmitter is synchronized with the frequency band of the wideband receiver.
